(19) United States
(12) Patent Application Publication
(10) Pub. No.: US 2023/0335957 A1
(43) Pub. Date: Oct. 19, 2023

(54) INTERNAL WATERPROOF AND DUSTPROOF MODULE

(71) Applicant: Riming Du, Zhongshan (CN)

(72) Inventor: Riming Du, Zhongshan (CN)

(21) Appl. No.: 18/340,882

(22) Filed: Jun. 25, 2023

(51) Int. Cl. H01R 13/703; H01R 13/52

(52) U.S. Cl. CPC H01R 13/7036; H01R 13/5202

(57) ABSTRACT

The present disclosure relates to the technical field of sockets, in particular to an internal waterproof and dustproof module. The internal waterproof and dustproof module includes a front case and a protection door; the protection door is arranged inside the front case; a limiting post is arranged on a side surface of the front case; the limiting post penetrates through a middle case and a rear case in sequence; a sealing ring is arranged inside the middle case; and an L-pole connecting mechanism, an N-pole connecting mechanism, a first limiting mechanism, and a second limiting mechanism are respectively arranged inside the rear case.

### TECHNICAL FIELD

The present disclosure relates to the technical field of sockets, in particular to an internal waterproof and dustproof module.

### BACKGROUND

Socket, also referred to as power socket or switch socket, refers to a socket with one or more circuit connection wires that can be plugged. By the socket, various connection wires can be plugged. Generally, there are several modules inside a socket, allowing a plurality of plugs to be plugged into the socket simultaneously for operation. However, general modules have some disadvantages when used, for example, as follows:

When a general module is in use, a foreign object entering a device will directly come into contact with electrodes inside the module, causing a phenomenon that the foreign object is conductive. As a result, a certain potential safety hazard is posed to the device during use. At the same time, the device is poor in sealing property and cannot prevent water from entering the device.

### SUMMARY

The present disclosure aims to solve the above problems to provide an internal waterproof and dustproof module, which improves the problem that the existing internal waterproof and dustproof module has poor sealing property.

An internal waterproof and dustproof module is provided, including a front case and a protection door; the protection door is arranged inside the front case; a limiting post is arranged on a side surface of the front case; the limiting post penetrates through a middle case and a rear case in sequence; a sealing ring is arranged inside the middle case; and an L-pole connecting mechanism, an N-pole connecting mechanism, a first limiting mechanism, and a second limiting mechanism are respectively arranged inside the rear case. When the device is in use, the limiting post penetrates through the middle case and the rear case in sequence, and is then fixed by a bolt, so that the front case, the middle case, and the rear case are fixed. The sealing ring is made of a silica gel material, which can improve the sealing property of the device. The protection door can further improve the sealing property of the device.

Preferably, the L-pole connecting mechanism includes an L-pole copper sheet and a first connecting block; the L-pole copper sheet is arranged inside the rear case; the first connecting block is arranged on a side surface of the L-pole copper sheet; and the first connecting block is located inside the rear case. When the device is in use, the L-pole copper sheet is connected to an external line, and the L-pole copper sheet is connected to the first connecting block.

Preferably, a side surface of a second connecting block is connected with a second connecting plate; and a side surface of the second connecting plate is a slope. When the second connecting block is in contact with the first connecting block, the second connecting block can be communicated with the first connecting block, so that a current enters the second connecting block through the first connecting block, and then enters the second connecting plate through the second connecting block.

Preferably, the first limiting mechanism includes a first movable block and a first connecting plate; one side of the first movable block is connected with the rear case; the first connecting plate is arranged on a side surface of the first movable block; and an upper end of the rear case is connected with the first connecting block. When the first movable block moves upwards, the first movable block can be in contact with the first connecting block, so that the first connecting block is communicated with the first movable block, and the first movable block is connected to a surface of the first connecting plate.

Preferably, the second limiting mechanism includes a third connecting plate and a second movable block; the third connecting plate is located right below the second connecting plate; and the third connecting plate is arranged on a side surface of the second movable block. When the second connecting plate is in contact with the third connecting plate, a current can flow between the second connecting plate and the third connecting plate, and the current can also be conducted to the second movable block through the third connecting plate.

Preferably, the N-pole connecting mechanism includes a third connecting block and an N-pole copper sheet; the N-pole copper sheet is arranged inside the rear case; the third connecting block is arranged on a side surface of the N-pole copper sheet; the third connecting block is located inside the rear case; and the third connecting block is located right under the second movable block.

Preferably, a fourth connecting block is located below the third connecting block; a side surface of the fourth connecting block is connected with a fourth connecting plate; and the fourth connecting plate is located below the first connecting plate. The second movable block may drive the third connecting block to move when moving downwards, so that the third connecting block is in contact with the fourth connecting block. The first connecting plate may be in contact with the fourth connecting plate when moving downwards, so that the current can flow between the first connecting plate and the fourth connecting plate.

Preferably, a grounding copper sheet is arranged on a side surface of the rear case. The grounding copper sheet can directly conduct the current to the ground, which ensures that the device has no leakage phenomenon.

The present disclosure has the beneficial effects:

1. A foreign object or a substandard pin can only be plugged into the second connecting plate and the third connecting plate or plugged into the first connecting plate and the fourth connecting plate when plugged into the device, which cannot drive the first movable block and the second movable block to move. Therefore, no electric conduction phenomenon occurs when the foreign object or the substandard pin is plugged into the device.

2. The protection door and the sealing ring can be used to improve the sealing property of the device, which avoids water from entering the device to affect the use of the device.

### BRIEF DESCRIPTION OF THE DRAWINGS

FIG. 1 is a schematic diagram of an entire three-dimensional structure of the present disclosure;

FIG. 2 is a schematic diagram of an entire exploded structure of the present disclosure;

FIG. 3 is a schematic diagram of a front sectional structure of a rear case of the present disclosure; and

FIG. 4 is a schematic diagram of mounting of a module in a plugboard.

In the drawings: 1: front case; 2: protection door; 3: limiting post; 4: middle case; 5: sealing ring; 6: rear case; 7: L-pole copper sheet; 8: first connecting block; 9: first movable block; 10: first connecting plate; 11: second connecting block; 12: second connecting plate; 13: third connecting plate; 14: second movable block; 15: third connecting block; 16: fourth connecting block; 17: fourth connecting plate; 18: N-pole copper sheet; and 19: grounding copper sheet.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments. All other embodiments obtained by those of ordinary skill in the art based on the embodiments in the present disclosure without creative work shall fall within the protection scope of the present disclosure.

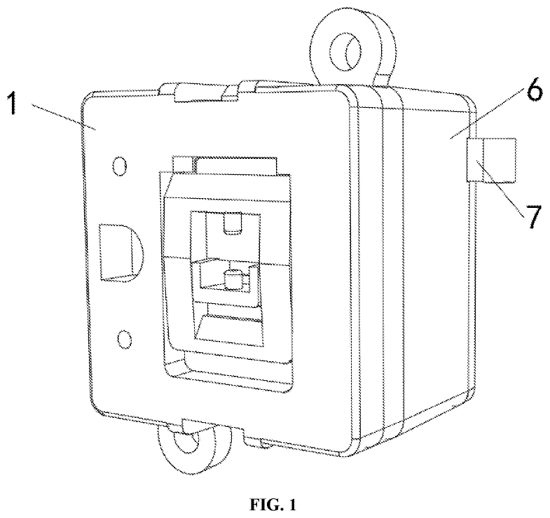

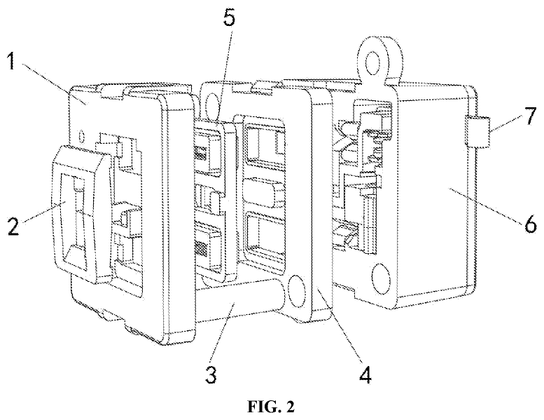

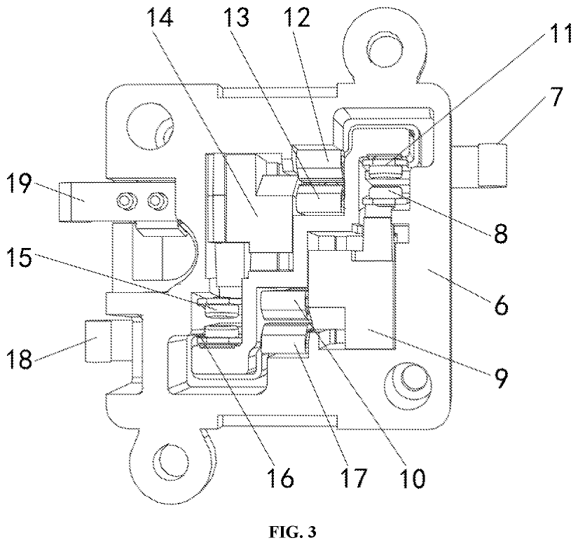

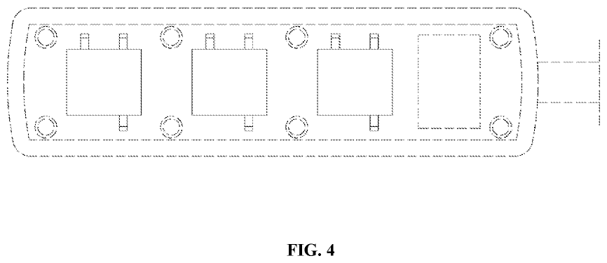

In specific implementation: As shown in FIG. 1 to FIG. 4, an internal waterproof and dustproof module includes a front case 1 and a protection door 2; the protection door 2 is arranged inside the front case 1; a limiting post 3 is arranged on a side surface of the front case 1; the limiting post 3 penetrates through a middle case 4 and a rear case 6 in sequence; a sealing ring 5 is arranged inside the middle case 4; and an L-pole connecting mechanism, an N-pole connecting mechanism, a first limiting mechanism, and a second limiting mechanism are respectively arranged inside the rear case 6. When the device is in use, the limiting post 3 penetrates through the middle case 4 and the rear case 6 in sequence, and is then fixed by a bolt, so that the front case 1, the middle case 4, and the rear case 6 are fixed. The sealing ring 5 is made of a silica gel material, which can improve the sealing property of the device. The protection door 2 can further improve the sealing property of the device.

The L-pole connecting mechanism includes an L-pole copper sheet 7 and a first connecting block 8; the L-pole copper sheet 7 is arranged inside the rear case 6; the first connecting block 8 is arranged on a side surface of the L-pole copper sheet 7; the first connecting block 8 is located inside the rear case 6; and a lower end of the first connecting block 8 abuts against the first limiting mechanism. When the device is in use, the L-pole copper sheet 7 is connected to an external line, and the L-pole copper sheet 7 is connected to the first connecting block 8.

A side surface of a second connecting block 11 is connected with a second connecting plate 12; and a side surface of the second connecting plate 12 is a slope. When the second connecting block 11 is in contact with the first connecting block 8, the second connecting block can be communicated with the first connecting block, so that a current enters the second connecting block 11 through the first connecting block 8, and then enters the second connecting plate 12 through the second connecting block 11.

The first limiting mechanism includes a first movable block 9 and a first connecting plate 10; one side of the first movable block 9 is connected with the rear case 6; the first connecting plate 10 is arranged on a side surface of the first movable block 9; and an upper end of the rear case 6 is connected with the first connecting block 8. When the first movable block 9 moves upwards, the first movable block 9 can be in contact with the first connecting block 8, so that the first connecting block 8 is communicated with the first movable block 9.

The second limiting mechanism includes a third connecting plate 13 and a second movable block 14; the third connecting plate 13 is located right below the second connecting plate 12; and the third connecting plate 13 is arranged on a side surface of the second movable block 14. When the second connecting plate 12 is in contact with the third connecting plate 13, a current can flow between the second connecting plate 12 and the third connecting plate 13, and the current can also be conducted to the second movable block 14 through the third connecting plate 13.

The N-pole connecting mechanism includes a third connecting block 15 and an N-pole copper sheet 18; the N-pole copper sheet 18 is arranged inside the rear case 6; the third connecting block 15 is arranged on a side surface of the N-pole copper sheet 18; the third connecting block 15 is located inside the rear case 6; and the third connecting block 15 is located right under the second movable block 14.

A fourth connecting block 16 is located below the third connecting block 15; a side surface of the fourth connecting block 16 is connected with a fourth connecting plate 17; and the fourth connecting plate 17 is located below the first connecting plate 10. The second movable block 14 may drive the third connecting block 15 to move when moving downwards, and the first connecting plate 10 may be in contact with the fourth connecting plate 17 when moving downwards, so that the current can flow between the first connecting plate 10 and the fourth connecting plate 17.

A grounding copper sheet 19 is arranged on a side surface of the rear case 6. The grounding copper sheet 19 can directly conduct the current to the ground, which ensures that the device has no leakage phenomenon.

According to the present disclosure, when the device is in use, a standard plug is plugged into the device, and the protection door 2 and the sealing ring 5 can ensure the sealing property of the device, and two pins are arranged on a side surface of the plug.

The pin on one side is in contact with the second connecting plate 12, the third connecting plate 13, and the second movable block 14. At this time, the second connecting plate 12 and the third connecting plate 13 can limit the pin. At this time, the pin can be driven by the slope of the second movable block 14 to move downwards to be in contact with the third connecting block 15, so that a channel is formed among the N-pole copper sheet 18, the third connecting block 15, the second movable block 14, and the pin. After the pin on the other side is plugged between the first connecting plate 10 and the fourth connecting plate 17, the first movable block 9 can be driven to move upwards to be in contact with the first connecting block 8, so that a channel is formed among the L-pole copper sheet 7, the first connecting block 8, the first movable block 9, and the pin. Thus, an electrical apparatus is powered on.

In addition, it should be understood that although this specification is described in accordance with the implementation modes, and each implementation mode does not only contain one independent technical solution. This narration in the specification is only for clarity. Those skilled in the art should regard the specification as a whole. The technical solutions in all the embodiments can also be appropriately combined to form other implementation modes that can be understood by those skilled in the art.

What is claimed is:

1. An internal waterproof and dustproof module, comprising a front case (1) and a protection door (2), wherein the protection door (2) is arranged inside the front case (1); a limiting post (3) is arranged on a side surface of the front case (1); the limiting post (3) penetrates through a middle case (4) and a rear case (6) in sequence; a sealing ring (5) is arranged inside the middle case (4); and an L-pole connecting mechanism, an N-pole connecting mechanism, a first limiting mechanism, and a second limiting mechanism are respectively arranged inside the rear case (6).

2. The internal waterproof and dustproof module according to claim 1, wherein the L-pole connecting mechanism comprises an L-pole copper sheet (7) and a first connecting block (8); the L-pole copper sheet (7) is arranged inside the rear case (6); the first connecting block (8) is arranged on a side surface of the L-pole copper sheet (7); and the first connecting block (8) is located inside the rear case (6).

3. The internal waterproof and dustproof module according to claim 2, wherein a side surface of a second connecting block (11) is connected with a second connecting plate (12); and a side surface of the second connecting plate (12) is a slope.

4. The internal waterproof and dustproof module according to claim 3, wherein the first limiting mechanism comprises a first movable block (9) and a first connecting plate (10); one side of the first movable block (9) is connected with the rear case (6); the first connecting plate (10) is arranged on a side surface of the first movable block (9); and an upper end of the rear case (6) is connected with the first connecting block (8).

5. The internal waterproof and dustproof module according to claim 4, wherein the second limiting mechanism comprises a third connecting plate (13) and a second movable block (14); the third connecting plate (13) is located right below the second connecting plate (12); and the third connecting plate (13) is arranged on a side surface of the second movable block (14).

6. The internal waterproof and dustproof module according to claim 5, wherein the N-pole connecting mechanism comprises a third connecting block (15) and an N-pole copper sheet (18); the N-pole copper sheet (18) is arranged inside the rear case (6); the third connecting block (15) is arranged on a side surface of the N-pole copper sheet (18); the third connecting block (15) is located inside the rear case (6); and the third connecting block (15) is located right under the second movable block (14).

7. The internal waterproof and dustproof module according to claim 6, wherein a fourth connecting block (16) is located below the third connecting block (15); a side surface of the fourth connecting block (16) is connected with a fourth connecting plate (17); and the fourth connecting plate (17) is located below the first connecting plate (10).

8. The internal waterproof and dustproof module according to claim 1, wherein a grounding copper sheet (19) is arranged on a side surface of the rear case (6).
